(19) United States
(12) Patent Application Publication
(10) Pub. No.: US 2026/0004239 A1
(43) Pub. Date: Jan. 1, 2026

(54) METHOD AND PICKING WAREHOUSE FOR PICKING GOODS OF DIFFERENT PICKING ORDERS

(71) Applicant: TGW Logistics GmbH, Marchtrenk (AT)

(72) Inventors: Timothy LINDLEY, Schwerte (DE); Christoph PAUZENBERGER, Pollham (AT)

(73) Assignee: TGW Logistics GmbH, Marchtrenk (AT)

(21) Appl. No.: 18/879,570

(22) PCT Filed: Jun. 28, 2023
(86) PCT No.: PCT/AT2023/060206

§ 371 Date: Dec. 27, 2024

(30) Foreign Application Priority Data
Jun. 30, 2022 (AT) A 50479/2022

(51) Int. Cl. G06Q 10/087; B65B 57/00; B65G 1/137

(52) U.S. Cl. CPC G06Q 10/08741; B65B 57/00; B65G 1/1378; B65G 2209/02

(57) ABSTRACT

A method and an order picking warehouse is for picking and packaging articles. The order picking warehouse comprises an order management system, transport loading aids, an automatic unloading station, a provisioning device for providing a shipping package or a collective loading aid at the unloading station and a packaging station. Picking orders are acquired and the articles are provided in transport loading aids and transported to the unloading station. At the unloading station, optionally a shipping package or a collective loading aid, into which the articles are reloaded from the transport loading aids, is provided on the basis of the picking order. The filled shipping package can be transported away and shipped to an article recipient. The filled collective loading aid, however, is provided at the packaging station, where the articles are reloaded from the collective loading aid into a secondary package.

### BACKGROUND

The disclosure relates to a method for picking and packaging articles and an order picking warehouse for executing the method, as described in the preambles of claims 1 and 20.

There is an increased requirement for order picking warehouses operated in an automated manner to be able to handle orders from both e-commerce (B2C) and retail (B2B). Different distribution channels are served. In the field, this is also referred to as “omnichannel.” In e-commerce, order quantities are usually small, the articles have the most varied article characteristics, such as dimensions and/or shapes. This entails predominantly small-format and/or most diverse shipping packages. In contrast, order quantities in retail are usually high, the articles are of similar article characteristics, such as dimensions and/or shapes. This entails predominantly large-format and/or similar-type shipping packages.

It has become apparent that orders in e-commerce require a considerably higher number of different shipping packages than orders in retail. In particular, the variance of the formats (dimensions) and/or packaging materials (cardboard, plastic) of the shipping packages spreads substantially more in e-commerce than in retail.

The shipping packages are, for example, packaging boxes, shipping envelopes, shipping bags and suchlike. It is crucial that the shipping package match the article order (order quantity, article characteristics and suchlike) and the packaging volume be size-optimized in order to minimize a transport volume and save transport costs.

Packaging boxes are preferably provided prefabricated and as standardized types of shipping package with different formats (dimensions). When automatic packaging provisioning machines are used, the packaging boxes can be matched individually to the article order and made to size. Also shipping envelopes which are provided prefabricated and as standardized types of shipping package with different formats (dimensions) are often used. Shipping bags (plastic shipping envelopes) can be matched individually to the article order and made to size. These shipping bags are made, for example, of plastic, so-called polybags, or paper.

To operate the process of packaging article orders in shipping boxes in an automated manner, automatic packaging provisioning machines, for example box erectors, box sealers, box coverers and/or automatic box packaging machines, can be used.

Automatic box erectors have a relatively simple structure and use a prefabricated carton blank, which can be stored in a collapsed initial state so as to be space-saving. As soon as a shipping box is required, a prefabricated carton blank can be erected at an automatic box erector and foldable bottom flaps can be glued together to form the bottom.

Such an automatic box erector can comprise
a magazine for providing carton blanks in a collapsed initial state,
a separation device for transferring a separated carton blank from the magazine,
an erector device for opening the separated carton blank into an opened use state,
a folding device for folding the bottom flaps of a box bottom and/or
a sealing device for gluing together the bottom flaps of the box bottom with an adhesive tape and/or hot-melt glue (hot adhesive).

Such automatic box erectors can process preferably different carton blanks in order to provide types of shipping package of different formats (dimensions).

A sealing of an open-top shipping box takes place either manually or automatically at a box sealer after the article has been placed down.

In an automatic box sealer, top flaps provided at a shipping box can be folded and the top flaps can be glued together to form the cover. To this end, the prefabricated carton blank comprises also foldable top flaps.

Such an automatic box sealer can comprise
a folding device for folding the top flaps of a box cover and
a sealing device for gluing together the top flaps of the box cover with an adhesive tape and/or hot-melt glue (hot adhesive).

Should the shipping box not comprise any foldable top flaps, the open-top shipping box can be closed using an additionally manufactured cover.

A sealing of an open-top shipping box takes place either manually or automatically at a box coverer after the article or has been placed down.

Such an automatic box coverer can comprise
a magazine for providing carton blanks,
a separation device for transferring a separated carton blank from the magazine,
a cover placement device for placing a cover on the open-top shipping package,
a folding device for folding over a cover edge of the box cover,
a sealing device for gluing the cover edge with a hot-melt glue (hot adhesive), and/or
a sealing device (banding machine) for strapping the shipping package and the cover with one or multiple strapping bands.

Automatic box packaging machines, in contrast, have a relatively complex structure, while offering the possibility to manufacture different carton blanks from an endless cardboard sheet that are specially size-matched to the article orders. The article orders are supplied to the box packaging machine respectively with a loading aid or without a loading aid (for example container) and the articles of an article order are placed down respectively onto a carton blank. Subsequently, the carton blank is made into the shipping box in a folding device by folding the box sections forming the side walls and sealed in a sealing device by gluing together box sections with a hot-melt glue (hot adhesive).

The same flexibility is provided by automatic shipping bag packaging machines, at which different shipping bags that are specially size-matched to the article orders can be manufactured. After the article of an article order has been placed into the shipping bag, the shipping bag that is open on one side is sealed, in particular glued or bonded.

In known order picking warehouses, articles are first picked and the picked articles are then manually packed into a shipping package at a packing station.

EP 3 581 524 A1 and WO 2020/140133 A2 disclose a method for the automatic picking and optionally automatic packaging of articles in an order picking warehouse, in which the articles are transported to an automatic unloading station with transport loading aids and the transport loading aids are unloaded in an order-oriented manner at the unloading station. Subsequently, the articles for a picking order are transported, preferably in transport containers, from the unloading station to a packaging station, where they are reloaded into a secondary package. According to EP 3 581 524 A1, an unloading of the articles immediately into a shipping package at the unloading station is not provided. In other words, the unloading operation and the packaging operation are necessarily separated from each other, irrespective of what picking orders are processed. Each picking order is transported to the packaging station. Associated with this are an increased transport volume and a repeated manipulation of the articles for each article order. Therefore, while this known order picking warehouse can be operated with a high performance for handling orders from e-commerce (B2C), it reaches its performance limits prematurely when handling orders from retail (B2B).

According to one embodiment of WO 2020/140133 A2, either a single article is transported from the unloading station to the packaging station without an additional transport container or multiple bundled articles are transported from the unloading station to the packaging station without an additional transport container. Associated with this are frequent disruptions during the transport from the unloading station to the packaging station on the one hand and a repeated manipulation of the articles for each article order on the other hand.

WO 2020/140133 A2 also discloses an embodiment, according to which articles for a picking order are transferred immediately into a shipping package at the unloading station.

Also known from WO 2019/195871 A1 and WO 2012/024714 A2 is an unloading station for unloading a transport loading aid loaded with one or multiple articles in which the one or multiple articles can be unloaded immediately into a shipping box. The transport loading aid of WO 2019/195871 A1 is a transport bag and the transport loading aid of WO 2012/024714 A2 is a transport container, which comprises a container bottom that can be opened.

### OVERVIEW

It is one object of the disclosure to create an improved method for picking and packaging articles in an order picking warehouse. In particular, most diverse article orders are to be packaged as needed and with as few handling steps as possible. It is also an object of the disclosure to create an improved order picking warehouse for picking and packaging articles.

The object of the disclosure is achieved with a method of the kind mentioned in the beginning by performing the following steps:
processing a first picking order and a second picking order, comprising the steps:
selectively providing a shipping package or a collective loading aid at the unloading station by a provisioning device preferably operated in an automated manner,
wherein the shipping package is configured for receiving one or multiple articles for the first picking order and intended for being delivered to an article recipient,
wherein the collective loading aid is configured for assembling one or multiple articles for the second picking order,
order-oriented (automatic) unloading of the articles for the first picking order by transferring one or multiple articles from one or multiple transport loading aids into the shipping package, which is provided at the unloading station, or order-oriented (automatic) unloading of the articles for the second picking order by transferring one or multiple articles from one or multiple transport loading aids into the collective loading aid, which is provided at the unloading station,
transporting the shipping package or the collective loading aid away from the unloading station by a conveying system preferably operated in an automated manner after the one or multiple articles have been transferred into the shipping package or into the collective loading aid,
reloading the one or multiple articles from the collective loading aid into a secondary package, which is intended for being delivered to an article recipient, at a packaging station once the second picking order has been processed at the unloading station.

The object of the disclosure is further achieved by an order picking warehouse of the kind mentioned in the beginning in which the automatic unloading station is configured for processing a first picking order and a second picking order and comprises:
a provisioning device for selectively providing (optionally) a shipping package or a collective loading aid at the unloading station,
   wherein the shipping package is configured for receiving one or multiple articles for the first picking order and intended for being delivered to an article recipient,
   wherein the collective loading aid is configured for assembling one or multiple articles for the second picking order,
an unloading device for the order-oriented unloading of the articles for the first picking order by transferring one or multiple articles from one transport loading aid or multiple transport loading aids into the shipping package, which is provided at the unloading station, or for the order-oriented unloading of the articles for the second picking order by transferring one or multiple articles from one transport loading aid or multiple transport loading aids into the collective loading aid, which is provided at the unloading station, and
a conveying system for transporting the shipping package or the collective loading aid away from the unloading station, in particular after the one or multiple articles have been transferred into the shipping package or into the collective loading aid,
and the order picking warehouse further comprises:
a packaging station for reloading the one or multiple articles from the collective loading aid into a secondary package, which is intended for being delivered to an article recipient once the second picking order has been processed at the unloading station and which is connected to the unloading station in terms of conveyance by the conveying system for transporting the collective loading aid.

In accordance with the disclosure, diverse picking orders, in particular a first picking order and a second picking order, are processed at an automatic unloading station. The first picking order and second picking order can each comprise at least one order line, wherein each order line specifies an article according to its type of article and its number of the articles of this type of article comprised by the picking order.

Preferably, the first picking order and the second picking order are processed (sequentially) in consecutive processing steps. Optionally, the first and second picking orders can also be processed simultaneously (in parallel).

A selective (optional) providing of a shipping package or of a collective loading aid enables either the first picking order or the second picking order to be processed. The selective provision is preferably executed by a provisioning device operated in an automated manner.

Advantageously, the provisioning device comprises a supply device, in particular the article takeover position, and an automatic conveying system.

The provisioning device for the selective provision can be used to provide optionally a shipping package or a collective loading aid on the one hand and/or simultaneously a shipping package and a collective loading aid on the other hand at the unloading station.

The acquired picking orders comprise in particular first and second picking orders, which are of different types. Here, it can be provided that a first picking order is to be assembled in a shipping package and a second picking order is to be assembled in a collective loading aid. When acquiring the picking orders, it can in particular be determined for each picking order, for example on the basis of a packaging requirement as described below, whether it is a first or second picking order. As described below, this may depend, for example, on the article recipient, on a picking order volume, on a number of articles comprised by the respective picking order or suchlike.

The one or multiple articles of an article order for the first picking order are picked directly into a shipping package, which is intended for being delivered to an article recipient, at the unloading station.

The article recipient can be an end customer, for example if the order is an order from e-commerce, or a sales outlet, for example if the order is an order from retail.

The one or multiple articles of an article order for the second picking order, however, are not picked into a shipping package at the unloading station but into a collective loading aid, which is intended for assembling one or multiple articles for the second picking order.

As a rule, the collective loading aid is not intended as a shipping package and therefore not intended for being delivered to an article recipient.

The shipping package is preferably designed by a packaging box. Such a packaging box is preferably prefabricated and has a standardized format (dimension). The packaging box has a bottom and side walls rising up from it. Preferably, also a cover is provided, though this need not necessarily be the case. The bottom simultaneously forms a transport surface, which is designed such that a transport on a conveying system operated in an automated manner is possible. An automatic transporting of a (empty) shipping package on a conveying system toward the unloading station and an automatic transporting of a (picked) shipping package on a conveying system away from the unloading station are thus possible.

Preferably, an automatic box erector as described in detail above and not explained repetitively again in this context is used.

The provisioning device can comprise the automatic box erector, which is connected, in terms of conveyance, to the conveying system operated in an automated manner for transporting a shipping box in order to transport erected shipping boxes from the automatic box erector to the unloading station.

Alternatively, the automatic box erector can be provided in addition to the provisioning device. The erected shipping boxes are removed from the automatic box erector and transferred to a shipping package buffer of the provisioning device. This can be done manually by a warehouse worker or automatically by a supply device. The supply device comprises a conveying system and/or a robot, for example.

Independent of this, it is possible that an automatic box erector is not provided and the packaging boxes are already prepared, which are handed over from a shipping package buffer of the provisioning device to the conveying system operated in an automated manner for transporting a shipping box and are transported to the unloading station by it.

The collective loading aid is preferably designed by a transport container, a tray or suchlike. The collective loading aid has a bottom and side walls rising up from it. The bottom simultaneously forms a transport surface, which is designed such that a transport on a conveying system operated in an automated manner is possible. An automatic transporting of a (empty) collective loading aid on a conveying system toward the unloading station and an automatic transporting of a (picked) collective loading aid on a conveying system away from the unloading station is thus possible.

In accordance with the disclosure, an order-oriented unloading of the articles for the first picking order takes place at the automatic unloading station by transferring one or multiple articles from one or multiple transport loading aids into the shipping package, which is provided at the unloading station. If an article is stocked in a transport loading aid and multiple of the same or different articles are required for the first picking order, the transport loading aids are transported into the unloading station separated and in succession and the articles are unloaded into the shipping package in succession. The shipping package remains in the unloading station until the shipping package has been maximally loaded or the first picking order has been completed. It proves expedient if the format of the shipping package is selected such that any and all articles for the first picking order can be unloaded into the shipping package.

After the unloading of the one or multiple articles, the shipping package is transported away from the unloading station by a conveying system preferably operated in an automated manner. The shipping package is preferably transported into a shipping area of the order picking warehouse.

The conveying system operated in an automated manner for transporting a (empty) shipping package and/or the conveying system operated in an automated manner for transporting a (loaded) shipping package comprises a stationary conveying device, for example a roller conveyor, a belt conveyor and/or suchlike, or a mobile conveying system, for example a driverless transport system with one or multiple autonomously movable transport vehicles, each of which are configured for transporting the shipping package. An autonomously movable transport vehicle is also known by the term “autonomous guided vehicle” (“AGV” in short) or “autonomous mobile robot” (“AMR” in short).

In accordance with the disclosure, an order-oriented unloading of the articles for the second picking order takes place at the automatic unloading station by transferring one or multiple articles from one or multiple transport loading aids into the collective loading aid, which is provided at the unloading station. If an article is stocked in a transport loading aid and multiple of the same or different articles are required for the second picking order, the transport loading aids are transported into the unloading station separately and in succession and the articles are unloaded into the collective loading aid in succession. The collective loading aid remains in the unloading station until the shipping package has been maximally loaded or the second picking order has been completed. If the second picking order comprises more articles than can be accommodated in a collective loading aid, a first collective loading aid is maximally loaded first and one or multiple other collective loading aids are loaded subsequently, in particular until all articles of the second picking order are located in a collective loading aid.

After the unloading of the one or multiple articles, the collective loading aid is transported away from the unloading station by a conveying system preferably operated in an automated manner. The collective loading aid is transported to a packaging station, in particular not transported into the shipping area of the order picking warehouse.

The conveying system operated in an automated manner for transporting a (empty) collective loading aid and/or the conveying system operated in an automated manner for transporting a (loaded) collective loading aid comprises a stationary conveying device, for example a roller conveyor, a belt conveyor and/or suchlike, or a mobile conveying device, for example a driverless transport system with one or multiple autonomously movable transport vehicles, each of which are configured for transporting a collective loading aid. An autonomously movable transport vehicle is also known by the term “autonomous guided vehicle” (“AGV” in short) or “autonomous mobile robot” (“AMR” in short).

Preferably, the conveying system operated in an automated manner is designed for transporting a (empty) shipping package and for transporting a (empty) collective loading aid on the one hand, and the conveying system operated in an automated manner is designed for transporting a (loaded) shipping package and for transporting a (loaded) collective loading aid on the other hand.

In the packaging station, the one or multiple articles are reloaded from the collective loading aid into a secondary package. The secondary package is intended for being delivered to an article recipient.

At the packaging station, different secondary packages are provided and/or immediately produced. For example, boxes and/or shipping envelopes which are provided prefabricated and as standardized types of secondary package with different formats (dimensions) can be used. If automatic packaging provisioning machines are used, secondary packages, in particular secondary package boxes and/or shipping bags (plastic shipping envelopes), can be manufactured so as to be individually matched to the article order and made to size. The shipping bags are especially made of plastic and are also referred to as polybags.

If an automatic packaging provisioning machine is used, the reloading of the one or multiple articles from the collective loading aid into the secondary package can take place during the manufacture of the secondary package.

The automatic packaging provisioning machine for manufacturing a secondary package box is described in detail above and is not explained repetitively again in this context.

One advantage achieved with the method for picking and packaging articles in accordance with the disclosure and the order picking warehouse in accordance with the disclosure is in particular that article orders for different picking orders are processed at the unloading station in a “packaging-based” manner. Within the scope of the disclosure, the term “packaging-based” is understood to mean that one or multiple articles for a first picking order (first article order) are reloaded from a transport loading aid into at least one shipping package directly at the unloading station, whereas articles for a second picking order (second article order) are loaded from a collective loading aid into at least one secondary package at a packaging station arranged remote from the unloading station. This proves of advantage particularly if orders both from e-commerce (B2C) and from retail (B2B) are processed at an unloading station in an order picking warehouse.

Usually, orders from e-commerce (B2C) are less comprehensive; an order often comprises only a single article. Therefore, these orders require diverse and usually small-format secondary packages. At the packaging station, there is sufficient space to install an automatic packaging provisioning machine or even different packaging provisioning machines of different packaging technologies, for example. Furthermore, also prefabricated secondary packages of different types of secondary package can be provided in the packaging station.

In contrast to that, orders from retail (B2B) are more comprehensive and comprise a large number of articles. Accordingly, relatively large-format shipping packages are required. Here, a few different shipping packages which additionally differ only in their format are often sufficient. It is also of advantage that the articles for a first picking order (first article order) need not be reloaded multiple times. In other words, the handling effort for a large number of the quantity of articles to be picked decreases. This achieves not only a high picking performance but also a protection of the articles. In addition, due to the direct unloading of the one or multiple articles into the shipping package, the picking is particularly reliable and there are hardly any disruptions. Also, the picking is low-cost.

The unloading station is preferably configured as described in WO 2019/195871 A1 or WO 2018/130712 A1.

It is favorable if the acquired picking orders comprise one or multiple first picking orders to be assembled in a shipping package and one or multiple second picking orders to be assembled in a collective loading aid and if it is determined by the electronic order management system for each of the picking orders when being acquired whether the respective picking order is a first picking order or a second picking order. Expediently, the order management system of the order picking warehouse described is configured for executing this method step. The determining of whether it is a first or second picking order can be executed, for example, by evaluating the packaging requirement described below.

It is also of advantage if the providing of the shipping package comprises a providing of a number of standardized types of shipping package with different dimensions.

The providing of standardized packaging types enables differently dimensioned shipping packages to be provided for different requirements. As mentioned in the beginning, orders from retail often comprise many articles and have similar structures. Therefore, a low number of different types of shipping package, for example three or four types of shipping package, is often sufficient. A balanced mean between packaging that is as flexible and space-optimized as possible (many different dimensions) and low complexity and high process reliability (few different dimensions) can thus be achieved.

In this context, the dimension, in particular a format, of the shipping package is understood as a spatial dimension of a base area of the shipping package and spatial dimension of a height of the shipping package.

The shipping package can have a dimension of 600 mm×400 mm×400 mm, for example. This shipping package forms a first type of shipping package. The shipping package can have a dimension of 600 mm×400 mm×200 mm, for example. This shipping package forms a second type of shipping package. The shipping package can have a dimension of 400 mm×300 mm×300 mm, for example. This shipping package forms a third type of shipping package.

Furthermore, it can be favorable if the method comprises a providing of a number of different types of secondary package, wherein the number of different types of secondary package is higher than the number of standardized types of shipping package.

As orders from e-commerce are very different as a rule, an increased flexibility concerning the packaging dimensions is desirable. This can be achieved by the larger number of different types of secondary package.

Analogously to the types of shipping package, the different types of secondary package can also have different dimensions. For example, the secondary package of a first type of secondary package can have a dimension of 200 mm×200 mm×50 mm. Here, a number of differently dimensioned types of secondary package can be provided, which are not specified in detail.

Alternatively or additionally, it is conceivable that the types of secondary package differ by different secondary package materials. For example, one type of secondary package can comprise secondary packages made of plastic and another type of secondary package secondary packages made of cardboard. The secondary package can thus be configured in particular as a shipping bag, for example as a polybag, or as a box, in particular as a cardboard box.

It is further expedient if shipping packages of the different types of shipping package are provided at the unloading station and secondary packages of the different types of secondary package are provided at the packaging station.

Preferably, it is provided that the providing of the shipping package further comprises:
a selecting of one of the types of shipping package on the basis of the first picking order by a control unit and
a transporting of a shipping package of the selected type of shipping package to an article takeover position at the unloading station by an automated conveying system, in particular in order to provide the shipping package at the unloading station.

The selecting of the types of shipping package is preferably based on a scope of the first picking order, i.e. a number of articles comprised by the first picking order and/or a need for space required by these articles. The type of shipping package is preferably selected such that all articles comprised by the first picking order can be received in a shipping package or that as few shipping packages as possible are required for the first picking order on the one hand, and such that as little unused volume as possible remains on the other hand. The selecting of the type of shipping package is thus executed so as to be essentially volume-optimized.

Furthermore, the conveying system operated in an automated manner can be configured, for example, as a stationary or mobile conveying system, as described above.

It is of advantage if the providing of the collective loading aid comprises a providing of a preferably single type of collective loading aid and a transporting of a collective loading aid of the type of collective loading aid to an article takeover position at the unloading station by an automated conveying system. The collective loading aid is preferably configured as a container.

It can be provided here that the shipping package is provided at a first article takeover position and the collective loading aid is provided at a second article takeover position at the unloading station.

It is further advantageous if a single article takeover position is provided at the unloading station, at which the article or the articles can be taken over selectively by the shipping package, in particular by the shipping package of the selected type of shipping package, for the first picking order or by the collective loading aid for the second picking order.

It is favorable if a predominant number, in particular at least 50%, particularly preferably at least 60%, 75% or 90%, of transport loading aids filled with articles stock a single article.

In this context, it can be advantageous if a remaining number of the transport loading aids filled with articles stocks more than one article of a single type of article.

It is provided particularly preferably that the transport loading aids filled with articles each stock a single article.

Furthermore, a plurality of empty transport loading aids, i.e. transport loading aids not filled with articles, can be provided.

It is advantageously provided that the transport loading aids are sorted into a particular sequence by an automatic sorting device and are separately transported to an article transferring position at the automatic unloading station in this sequence, in particular to one of the article transferring positions described above, at which one or multiple articles required for the first or second picking order are respectively transferred from the transport loading aids.

The automatic sorting device is preferably connected to the electronic control system. The electronic control system is further configured for controlling the automatic sorting device.

It is favorable if the transport loading aids are sorted by an automatic sorting device into a first group of transport loading aids, which contains the one or multiple articles of the first picking order, and/or into a second group of transport loading aids, which contains the one or multiple articles of the second picking order, and the transport loading aids are transported separated according to groups of transport loading aids and individually to an article transferring position, at which the articles are transferred in succession from the transport loading aids. The automatic sorting device used to this end can be the automatic sorting device described above or another sorting device.

Preferably, a sequential processing of the first picking order and of the second picking order takes place. This means that the first picking order and the second picking order are processed in succession. The automatic sorting device can sort the articles and/or the transport loading aids into a sequence determined for this purpose.

To enable a sequential processing of the first and second picking orders, the articles can be transported to the unloading station separated according to article groups, so that first the one or multiple articles of the first picking order and subsequently the one or multiple articles of the second picking order are provided at the unloading station.

It is favorable if the articles are provided on a buffer track in a sorted sequence and are transported into the automatic unloading station separately and in succession in the sorted sequence.

Preferably, it is provided that the transport loading aids respectively comprise a transport bag and are moved along an overhead conveying system and/or an overhead conveying device, wherein the articles are stocked in the transport bags.

Preferably, the first picking order and the second picking order differ in an order structure, in particular by at least one order line each.

Furthermore, it can be advantageous if at least one order line and a packaging requirement are acquired in terms of data technology for each, in particular first and/or second, picking order, wherein the order line specifies an article according to its type of article and the number of the articles of this type of article comprised by the (respective) picking order and wherein the packaging requirement specifies whether a shipping package or a secondary package is to be used. The packaging requirement can therefore optionally specify that a shipping package is to be used or that a secondary package is to be used.

It is further advantageous if the use of a shipping package and its type of shipping package is specified with the packaging requirement if the number of standardized types of shipping package with different dimensions is provided.

Furthermore, the use of a secondary package and its type of secondary package can be specified with the packaging requirement if a number of types of secondary package with different dimensions and/or different packaging materials is provided.

To provide a particularly volume-optimized secondary package, it can be provided that the secondary package is made to size, individually and on the basis of the second picking order, by an automatic packaging provisioning machine.

Here, it can be provided that the secondary package is provided first, is filled with articles and a height of the secondary package is subsequently reduced down to a filling level.

It can be provided that the packaging station comprises an automatic packaging provisioning machine, which is configured for making the secondary package to size, individually and on the basis of the second picking order.

Alternatively, the secondary package can be individually manufactured by first determining a filling volume of the secondary package which is required to receive the one or multiple articles in the secondary package and the secondary package is subsequently manufactured to a precise fit.

It is advantageously provided that the conveying system has an overhead conveying device for transporting the transport loading aids to the automatic unloading station and for transporting the transport loading aids away from the automatic unloading station and the transport loading aids respectively comprise a transport bag for transporting one or multiple articles.

It is favorable if the transport bag comprises a bag body which is adjustable between a transport position and an unloading position, wherein the one or multiple articles can be supported in the bag body in the transport position and the one or multiple articles can be unloaded from the bag body in the unloading position.

Here, it can be provided that the transport bag comprises a bag body that is adjustable between a transport position and an unloading position and a storage space for transporting the article, wherein the article can be supported in the storage space in the transport position and the article can be unloaded from the storage space in the unloading position.

Preferably, it is provided that the unloading station comprises an opening device, by means of which the bag body can be adjusted from the transport position to the unloading position for unloading a transport loading aid. The opening device can be configured as described in WO 2018/130712 A1, for example. Alternatively, the opening device can also be configured as an opening and closing device like in WO 2019/195871 A1.

It is favorable if the provisioning device comprises a shipping package buffer with buffer locations for providing a number of standardized types of shipping package with different dimensions and a transfer device for dispensing a shipping package selected from one of the types of shipping package on the basis of the first picking order.

The shipping package buffer can be configured and/or provided by the box erector, for example. Alternatively, the shipping package buffer can also be formed by a conveying system between the box erector and the unloading station.

It is further advantageous if the conveying system is connected to the transfer device in terms of conveyance and is configured for transporting a shipping package of the selected type of shipping package from the shipping package buffer to the unloading station, in particular to an article takeover position at the unloading station. As described above, the conveying system can be operated in an automated manner between the shipping package buffer and the unloading station and be configured as a stationary or mobile conveying system.

It can be provided that the shipping package buffer is connected to an electronic control unit, by which a selecting of one of the types of shipping package is executed on the basis of the first picking order and which is configured for controlling the transfer device.

Another advantage emerges if the provisioning device comprises a collective loading aid buffer with buffer locations for providing a number of collective loading aids and a transfer device for dispensing a collective loading aid on the basis of the second picking order.

Furthermore, it can be provided that the conveying system is connected to the transfer device in terms of conveyance and is configured for transporting a collective loading aid from the collective loading aid buffer to the unloading station. As described above, the conveying system can be operated in an automated manner between the collective loading aid buffer and the unloading station and be configured as a stationary or mobile conveying system.

It is favorable if the collective loading aid buffer is connected to an electronic control unit, in particular to the control unit described above, in order to control the transfer device.

It is advantageous if the conveying system is configured for transporting the shipping packages and the collective loading aids, in particular toward the unloading station and/or away from the unloading station.

It can advantageously be provided that the unloading device comprises a transferring unit, which is configured for taking over the article from the transport loading aid and transferring it to the shipping package or to the collective loading aid, wherein the transferring unit comprises a chute, onto which the article can be transferred, and a stop element, against which the article can be positioned by the force of gravity, wherein the stop element defines a bottom end of the chute and the chute has a handover unit, in particular a trap door, by which the article can be transferred downward. The chute enables a height difference between the transport loading aid and the handover unit to be overcome and thus a transferring height, i.e. a height difference between the transport loading aid and the shipping package or the collective loading aid, to be reduced, whereby a reliable and precise transferring of the article is enabled.

Here, the article can be handed over from the transport loading aid to the chute. For example, the transport loading aid can be tipped, so that the article slides out of the transport loading aid onto the chute. Subsequently, the article can slide along the chute by the force of gravity until the article rests against the stop element.

The stop element is preferably arranged such that the article is positioned above and/or on the handover unit when the article rests against the stop element.

To transfer the articles into the shipping package or into the collective loading aid in a simple manner, the conveying system is preferably configured for positioning the shipping package or the collective loading aid below the handover unit, in particular below the trap door, so that the article can be transferred by being dropped from the chute into the shipping package or into the collective loading aid. Here, the article can be transferred, for example by opening the trap door downwardly.

It is further advantageous if a collecting unit is arranged between the conveying system and the chute below the handover unit, in particular below the trap door, which collecting unit comprises a support for receiving an article transferred by the handover unit, in particular by the trap door, and a scraper, wherein the support and the scraper are movable relative to each other along a horizontal axis in order to wipe the article off the support, and wherein the conveying system is configured for positioning the shipping package or the collective loading aid below the support, so that the article can be transferred into the shipping package or into the collective loading aid by being scraped off the support. Therefore, the article is not transferred immediately from the chute into the shipping package or into the collective loading aid but is first transferred onto the support in an intermediate step by the handover device, for example by opening the trap door. This ensures that the article can be transferred even more accurately into the shipping package or into the collective loading aid.

Furthermore, it can be provided that the support is mounted so as to be rotatable about a vertical axis. The article can thus be reoriented, in particular rotated, and/or repositioned before being transferred into the shipping package or into the collective loading aid. This enables the article to be transferred into different regions (quadrants) of the shipping package or of the collective loading aid.

To provide as gentle as possible a transition between the transport loading aid and the chute and thus optionally avoid excessive creasing of the article, it can be provided that the transferring unit comprises adjustment elements that are controllable, in particular by the control unit, by which adjustment elements an inclination of the chute can be set. The controllable adjustment elements can be used to set, in particular adapt, the inclination.

It is further favorable if the chute has an inclination of at least 15° up to a maximum of 45°, preferably of at least 20° up to a maximum of 35°, particularly preferably of 25°. This inclination can be set so as to be fixed or can be set by controllable adjustment elements, as described above.

To guide the article along the chute and/or center it on same, it can be provided that the chute comprises a lateral guide for the article along a longitudinal axis of the chute, in particular at both sides, and/or a V-shaped cross section.

To increase a packing density in the shipping package and/or in the collective loading aid, it can be provided that the transferring unit comprises a vibrating device, which is arranged below the trap door and is configured for pivoting the shipping package or the collective loading aid when the article is transferred into the shipping package or into the collective loading aid.

To pivot the shipping package or the collective loading aid, the vibrating device can in particular be configured for moving the shipping package or the collective loading aid in a pivoting plane along an elliptic or circular path. The pivoting thus essentially comprises a circular or elliptic movement. Preferably, the pivoting plane is aligned horizontally. Alternatively, it can be provided that the vibrating device is additionally configured for tilting the pivoting plane (continuously) about a horizontal axis in order to tilt and/or tip the shipping package or the collective loading aid. The pivoting thus essentially comprises the circular or elliptic movement and a tipping movement.

Alternatively, it can be provided that the vibrating device is configured for tilting and/or tipping the shipping package about a horizontal axis. The pivoting thus essentially comprises the tipping movement.

Within the scope of the present disclosure, “pivoting the shipping package or the collective loading aid” can therefore be understood to mean moving the shipping package or the collective loading aid in a (horizontal) plane along an elliptic or circular path and/or tilting the shipping package or the collective loading aid.

For the purpose of better understanding of the disclosure, it will be elucidated in more detail by means of the figures below.

### BRIEF DESCRIPTION OF THE FIGURES

The figures show in a respectively very simplified schematic representation:

FIG. 1 a schematic representation of an order picking warehouse;

FIG. 2 a transport loading aid in a perspective view;

FIG. 3a, 3b picking orders;

FIG. 4 a schematic representation of a packaging station;

FIG. 5 another schematic representation of a packaging station;

FIG. 6 a detail of the order picking warehouse;

FIGS. 7a to 7e a transferring unit for transferring articles from a transport loading aid.

### DETAILED DESCRIPTION OF THE EMBODIMENTS

First of all, it is to be noted that, in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure, and, in case of a change of position, are to be analogously transferred to the new position.

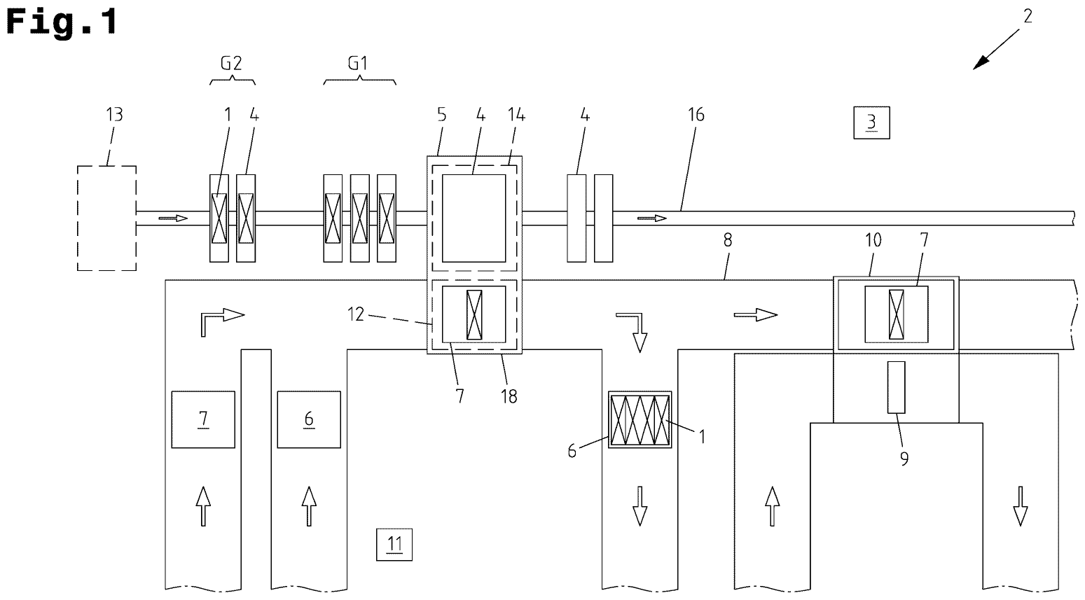

FIG. 1 shows an order picking warehouse 2 for picking and packaging articles 1. In such an order picking warehouse 2, a method for picking and packaging articles 1 can be executed, wherein picking orders K1, K2, in particular a first picking order K1 and a second picking order K2, are processed. The method is described in the context of FIG. 1 to FIG. 6.

The order picking warehouse 2 comprises an electronic order management system 3, by which the picking orders K1, K2 for orders by article recipients are acquired. The picking orders K1, K2 usually specify which articles 1 and/or types of article and/or how many articles 1, in particular how many articles 1 of a type of article, are required for an order.

Furthermore, the order picking warehouse 2 comprises a plurality of transport loading aids 4, in which the articles 1 are provided, and an automatic unloading station 5, at which the transport loading aids 4 can be unloaded. The articles 1 are transported to the unloading station 5 using the transport loading aids 4.

In the method for picking and packaging articles 1, a processing of the picking orders K1, K2 can be executed by providing optionally a shipping package 6 for a first picking order K1 or a collective loading aid 7 for a second picking order K2 at the unloading station 5. In FIG. 1, a collective loading aid 7 for processing a second picking order K2 is being provided at the unloading station 5.

At the unloading station 5, the articles 1 are unloaded in an order-oriented manner, wherein the articles 1 which are required for the respective picking order K1, K2 are transferred from a transport loading aid 4 or (in succession) from multiple transport loading aids 4 into the shipping package 6 in case of a first picking order K1 or are transferred into the collective loading aid 7 in case of a second picking order K2, as schematically represented in FIG. 1.

Once all articles 1 for the respective picking order K1, K2 are located in the shipping package 6 or in the collective loading aid 7, the shipping package 6 filled with articles 1 or the collective loading aid 7 filled with articles 1 is transported away from the unloading station 5, in particular using a conveying system 8, as indicated by arrows in FIG. 1.

To transport the shipping packages 6 and/or the collective loading aids 7 toward the unloading station 5 and/or away from the unloading station 5, the order picking warehouse 2 therefore preferably comprises the conveying system 8, which can be configured, for example, as a stationary conveying system 8 or as a mobile conveying system 8.

The shipping package 6 can be transported to a not explicitly represented shipping station, as schematically shown in FIG. 1 by the shipping package 6 filled with articles 1 and by the curved arrow.

In a subsequent step, the articles 1 for a second picking order K2 are reloaded from the collective loading aid 7 into a secondary package 9. To this end, the picking system 2 comprises a packaging station 10, to which the collective loading aid 7 is transported, in particular using the conveying system 8, as schematically indicated by the straight arrow.

At the packaging station 10, the secondary package 9 for the respective second picking order K2 can be provided. The reloading can take place manually or in an automated manner.

To process a first picking order K1, different types of shipping package with different dimensions can be provided. Preferably, the types of shipping package are standardized, so that a first type of shipping package has a first dimension, a second type of shipping package a second dimension and so on. In the order picking warehouse 2, a few, for example two, three or four types of shipping package can be provided.

On the basis of the first picking order K1, in particular on the basis of a need for space of the articles 1 comprised by the first picking order K1, a matching type of shipping package can be selected. This can be done using a control unit 11 of the order picking warehouse 2.

To process a second picking order K2, different types of secondary package can be provided. Here, it is in particular provided that more types of secondary package than types of shipping package are provided. A selecting of a matching type of secondary package can be executed on the basis of the second picking order K2, in particular on the basis of a need for space of the articles 1 comprised by the second picking order K2, using the control unit 11. Alternatively, it can be provided that the secondary package 9 for the respective picking order K2 is made to size, in particular on the basis of a need for space of the articles 1 comprised by the second picking order K2.

To transfer the picking orders K1, K2 from the order management system 3 to the control unit 11, it can be provided that the control unit 11 is connected to the order management system 3 in terms of data technology.

To reload the articles 1 from the transport loading aids 4 into the shipping package 6 or into the collective loading aid 7, these can be transported by the conveying system 8 to an article takeover position 12 at the unloading station 5.

Further, the transport loading aids 4 with the articles 1 can be provided at an article transferring position 14 of the unloading station 5, as shown in FIG. 1.

Optionally, the transport loading aid 4 can be sorted into a particular sequence by an optional automatic sorting device 13 of the order picking warehouse 2 and be provided at the article transferring position 14 at the unloading station 5 in this sequence. Here, those articles 1 which are required for the first picking order K1, in particular transport loading aids 4 which contain these articles 1, are grouped into a first group of transport loading aids G1 and/or those articles 1 which are required for the second picking order K2, in particular transport loading aids 4 which contain these articles 1, are grouped into a second group of transport loading aids G2, as shown in FIG. 1 by way of example.

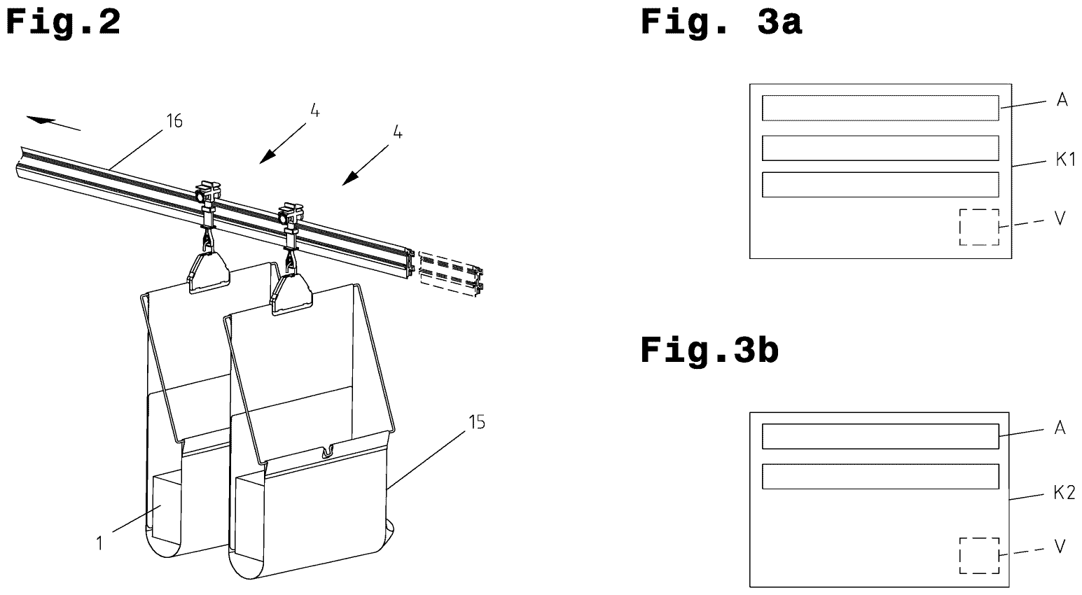

FIG. 2 shows an exemplary transport loading aid 4 in a perspective view, wherein the transport loading aid 4 comprises a transport carrier on the one hand, which is displaceable along a conveying system 16, in particular along an overhead conveying device. On the other hand, the transport loading aid 4 comprises a transport bag 15, preferably hanging on the transport carrier. The transport bag 15 comprises a bag body that is adjustable between a closed transport position and an opened unloading position. In FIG. 2, the transport bag 15 is represented in the closed transport position, in which the article 1 is received in the transport bag 15.

In the opened unloading position, the bag body is essentially unfolded, as schematically represented in FIG. 1 in the region of the unloading station 5. In this position, the article 1 can slide, in particular by the force of gravity, laterally out of the bag body if the bag body and/or a bottom of the bag body is tilted and/or tipped.

Furthermore, a first picking order K1 and a second picking order K2 are schematically represented in FIG. 3a and FIG. 3b. The picking orders K1, K2 respectively comprise at least one order line A. Essentially, the picking orders K1, K2 differ from each other in their order structure.

As represented in FIG. 3a and FIG. 3b, the picking orders K1, K2 can in particular differ from each other in a number of the order lines A.

The first picking order K1 represented by way of example comprises three order lines A and the second picking order represented by way of example comprises three order lines A. The order line A respectively specifies an article 1 according to its type of article and its number of the articles 1 of this type of article comprised by the picking order. Alternatively or additionally, the order structure of the picking orders K1, K2 can differ in a number of the articles 1 comprised by the picking order.

Furthermore, the picking orders K1, K2 can comprise a packaging requirement V, which specifies which type of packaging is to be used. For example, the packaging requirement V can specify for a first picking order K1 that a shipping package 6 is to be used. In addition, the packaging requirement V can also specify which type of shipping package is to be used. For a second picking order K2, the packaging requirement V can specify that a secondary package 9 is to be used. In addition, the packaging requirement V can also specify which type of secondary package is to be used. Alternatively, the packaging requirement V can also specify a measurement, in accordance with which the secondary package 9 is to be manufactured.

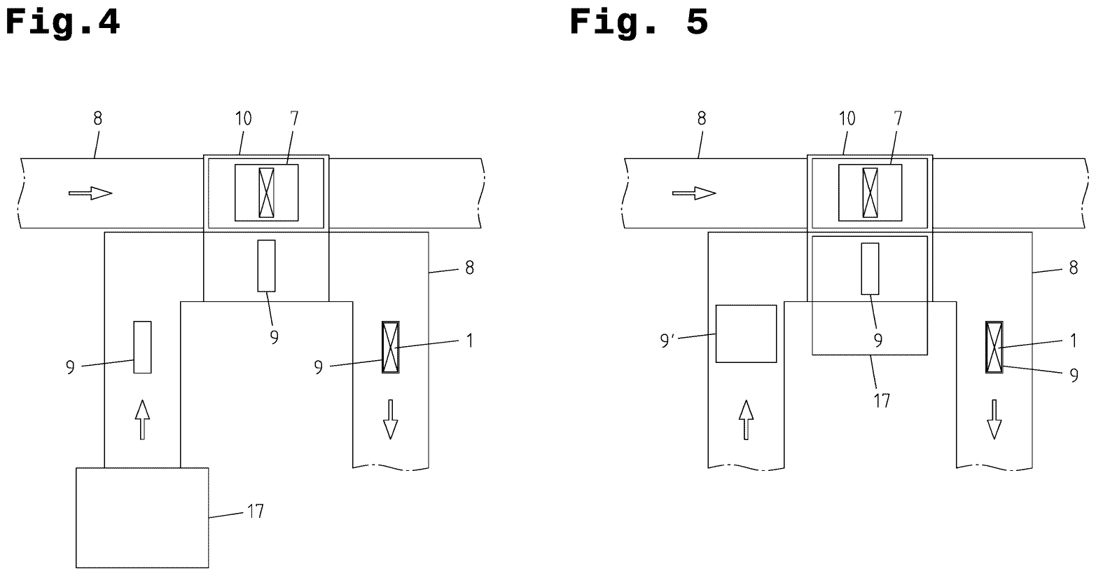

FIG. 4 and FIG. 5 show a detail of the order picking warehouse 2, wherein the packaging station 10 is represented schematically.

The secondary package 9 can be prepared and transported to the packaging station 10 by the conveying system 8 in an empty state and be provided there, as represented in FIG. 4 by the arrow pointing toward the empty secondary package 9. Here, it can be provided that the order picking warehouse 2 has a packaging provisioning machine 17, which is arranged upstream of the packaging station 10, as represented in FIG. 4. The packaging provisioning machine 17, for example a box erector, can be configured for manufacturing secondary packages 9 of different types of secondary package.

Alternatively, it can be provided that the packaging provisioning machine 17 is arranged at the packaging station 10, as shown in FIG. 5. Preferably, the packaging provisioning machine 17 configured for making to size a secondary package 9 required for the respective second picking order K2. Here, a carton blank 9′, for example, can be transported to the packaging provisioning machine 17 using the conveying system 8. The carton blank 9′ can be used to manufacture the secondary package 9 by the packaging provisioning machine 17.

Once the secondary package 9 is filled with articles 1, it can be transported away from the packaging station 10 using the conveying system, as indicated in FIG. 4 and FIG. 5 by the arrow pointing away from the secondary package 9 filled with articles 1.

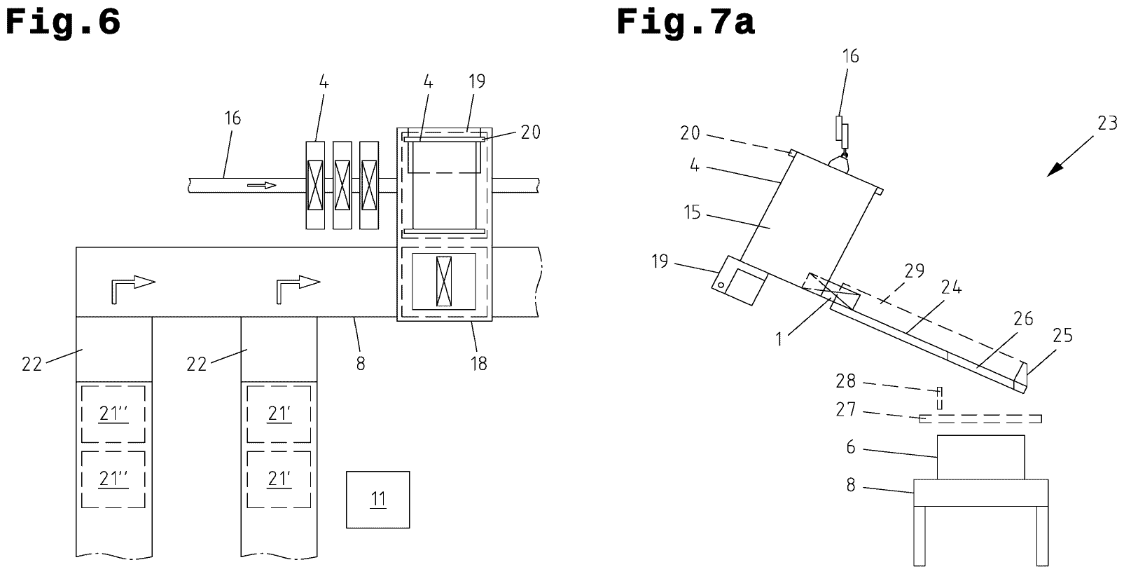

FIG. 6 shows another detail of the order picking warehouse 2. As can be seen in FIG. 6, it can be provided that the order picking warehouse 2 comprises a shipping package buffer with buffer locations 21′, at which shipping packages 6 can be provided, and/or a collective loading aid buffer with buffer locations 21″, at which collective loading aids 7 can be provided.

To (selectively) hand over a provided shipping package 6 or a provided collective loading aid 7 to the conveying system 8, the shipping package buffer and/or the collective loading aid buffer comprise a transfer device 22.

The control unit 11 described above can be configured for controlling the transfer device 22 such that it hands over a selected shipping package 6 or a collective loading aid 7 to the conveying system 8.

It is expedient if the unloading station comprises an unloading device 19, which is configured for moving the article 1 out of the transport loading aid 4. The unloading device 19 can be configured, for example, as a tipping device, which tilts a bottom of the transport bag 15 or the transport bag 15 itself, so that the article 1 can slide out of the transport bag 15 by the force of gravity when the transport bag 15 is provided in the unloading position.

Further, the unloading station 5 can comprise an opening device 20, which is configured for adjusting the transport bag 15 from the closed transport position to the opened unloading position (opened position).

Such an unloading station with an unloading device 19 and an opening device 20 is described in WO 2019/195871 A1 and in WO 2018/130712 A1, for example.

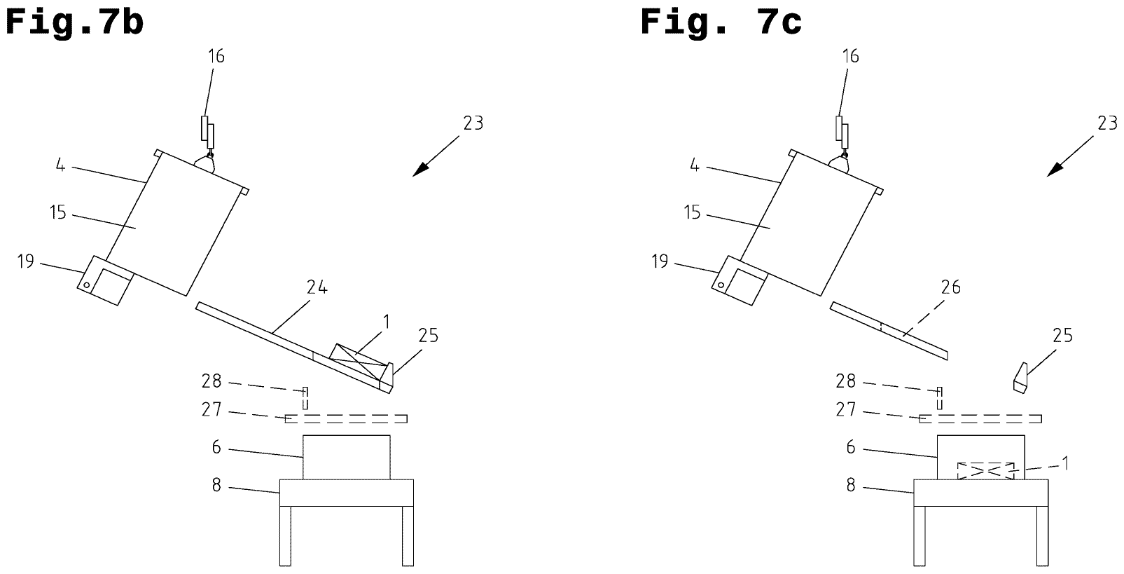

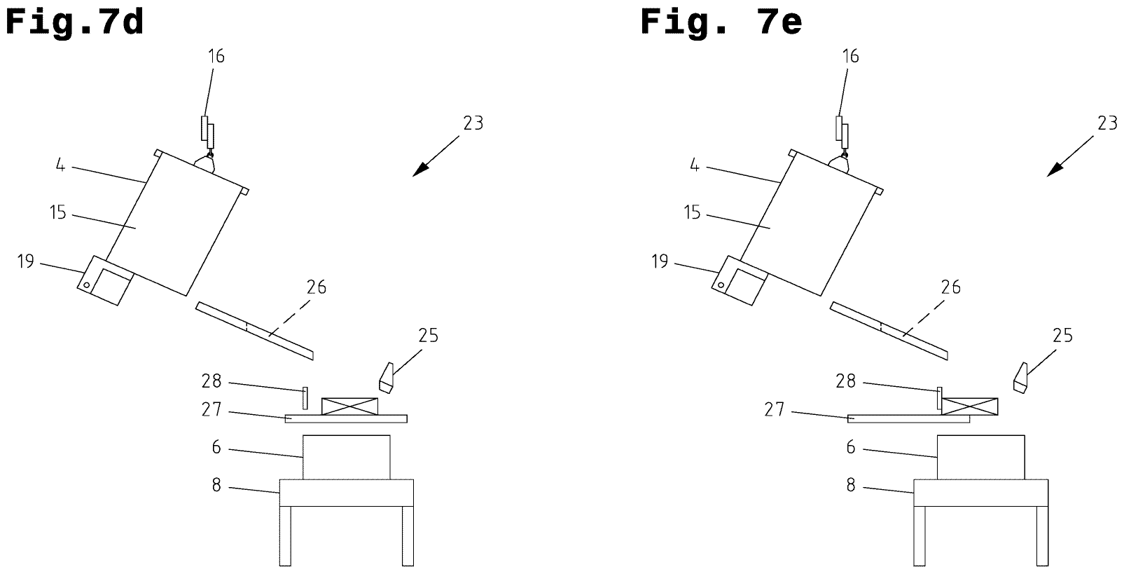

Furthermore, the unloading station 5 can comprise a transferring unit 23, which is configured for taking over articles 1 from the transport loading aid 4 and handing over articles 1 to the shipping package 6 or to the collective loading aid 7. An exemplary transferring unit 23 is shown in FIG. 7a to FIG. 7e.

The transferring unit 23 comprises a chute 24 with a stop element 25 and a handover unit 26, which can in particular be configured as a trap door.

Optionally, the transferring unit 23 can comprise a collecting unit having a support 27 and a scraper 28 marked with dashed lines, which collecting unit is arranged below the handover unit 26 and above the conveying system 8.

Further, the chute 24 can comprise an optional lateral guide 29 and/or a V-shaped cross section in order to secure and/or center the article 1 on the chute 24, which is marked with a dashed line in FIG. 7a only for reasons of clarity.

In FIG. 7a to FIG. 7e, a transport loading aid 4 is provided at the unloading station 5 in the opened position, wherein the transport loading aid 4 is tipped and/or a bottom of the transport loading aid 4 is tilted by the unloading device 19. The unloading device 19 can comprise an actuation element, which is configured as a pivotable arm, for example. The pivotable arm can tip the transport loading aid 4 by pivoting it upward. Other possible embodiments of the unloading device 19 are known from WO 2019/195871 A1, for example.

Due to an inclination of the transport loading aid 4, the article 1 can slide out of the transport loading aid 4, in particular out of the transport bag 15, onto the chute and thus be handed over from the transport loading aid 4 to the transferring unit 23, as represented in FIG. 7a.

Subsequently, the article 1 can slide, via the tilted chute 24, down to a bottom end of the chute 24, at which the article 1 is stopped by the stop element 25 at a defined position, as shown in FIG. 7b.

Due to an opening of the handover unit 26, for example of the trap door, the article 1 can be transferred by being dropped downward into the shipping package 6 provided below the handover unit 26 or into the collective loading aid 7 provided below the handover unit 26, as represented in FIG. 7c.

If the transferring unit 23 comprises an optional collecting unit as described above, the article 1 can be transferred onto the support 27 first by opening the handover unit 26 and by dropping the article 1 as shown in FIG. 7d.

From the support 27, the article 1 can be transferred into the shipping package 6 provided below the support 27 or into the collective loading aid 7 provided below the support 27, by wiping the article 1 off the support 27 by the scraper 28.

The wiping can be executed by the transferring unit 23 being moved horizontally to the side and the scraper 28 remaining in place, as represented in FIG. 7e. Alternatively, the support 27 can remain in place and the scraper 28 can be moved horizontally in order to push the article 1 off the support 27.

Finally, it should also be noted that the scope of protection is determined by the claims. However, the description and the drawings are to be adduced for construing the claims. Individual features or feature combinations from the different exemplary embodiments shown and described may represent independent inventive solutions.

In particular, it should also be noted that, in reality, the depicted devices can also comprise more, or also fewer, components than depicted. In some cases, the shown devices and/or their components may not be depicted to scale and/or be enlarged and/or reduced in size.

### TABLE OF REFERENCE NUMBERS

1 article
2 order picking warehouse
3 order management system
4 transport loading aid
5 unloading station
6 shipping package
7 collective loading aid
8 conveying system for shipping package or collective loading aid
9 secondary package
9′ carton blank
10 packaging station
11 control unit
12 article takeover position
13 sorting device
14 article transferring position
15 transport bag
16 conveying system for transport loading aid (e.g. transport bag)
17 packaging provisioning machine
18 provisioning device
19 unloading device
20 opening device
21′, 21″ buffer location
22 transfer device
23 transferring unit
24 chute
25 stop element
26 handover unit
27 support
28 scraper
29 lateral guide
A order line
G1, G2 group of transport loading aids
K1, K2 picking order
V packaging requirement

1. A method for picking and packaging articles in an order picking warehouse, comprising the method steps:
acquiring picking orders at an electronic order management system for orders by article recipients,
providing the articles in transport loading aids,
transporting the articles to an automatic unloading station by the transport loading aids, wherein:
processing a first picking order and a second picking order, comprising the steps:
selectively providing a shipping package or a collective loading aid at the unloading station,
wherein the shipping package is configured for receiving one or multiple articles for the first picking order and intended for being delivered to an article recipient,
wherein the collective loading aid is configured for assembling one or multiple articles for the second picking order,
order-oriented unloading of the articles for the first picking order by transferring one or multiple articles from one or multiple transport loading aids into the shipping package, which is provided at the unloading station, or order-oriented unloading of the articles for the second picking order by transferring one or multiple articles from one or multiple transport loading aids into the collective loading aid, which is provided at the unloading station,
transporting the shipping package or the collective loading aid away from the unloading station by a conveying system after the one or multiple articles have been transferred into the shipping package or into the collective loading aid,
reloading the one or multiple articles from the collective loading aid into a secondary package, which is intended for being delivered to an article recipient, at a packaging station once the second picking order has been processed at the unloading station.

2. The method according to claim 1, wherein the acquired picking orders, comprise one or multiple first picking orders to be assembled in a shipping package and one or multiple second picking orders to be assembled in a collective loading aid and it is determined by the electronic order management system for each of the picking orders, when being acquired whether the respective picking order, is a first picking order or a second picking order.

3. The method according to claim 1, wherein the providing of the shipping package comprises a providing of a number of standardized types of shipping package with different dimensions.

4. The method according to claim 3, further comprising:
providing of a number of different types of secondary package, wherein the number of different types of secondary package is higher than the number of standardized types of shipping package.

5. The method according to claim 4, wherein shipping packages of the standardized types of shipping package are provided at the unloading station and secondary packages of the different types of secondary package are provided at the packaging station.

6. The method according to claim 3, wherein the providing of the shipping package comprises:
a selecting of one of the types of shipping package on the basis of the first picking order by a control unit, and
a transporting of a shipping package of the selected type of shipping package to an article takeover position at the unloading station by an automated conveying system.

7. The method according to claim 1, wherein the providing of the collective loading aid comprises:
a providing of a preferably single type of collective loading aid, and
a transporting of a collective loading aid of the type of collective loading aid to an article takeover position at the unloading station by an automated conveying system.

8. The method according to claim 1, wherein a single article takeover position is provided at the unloading station, at which the an article can be taken over selectively by the shipping package.

9. The method according to claim 1, wherein a predominant number of transport loading aids filled with articles stocks a single article.

10. The method according to claim 9, wherein a remaining number of the transport loading aids filled with articles stocks more than one article of a single type of article.

11. The method according to claim 1, wherein the transport loading aids filled with articles respectively stock a single article.

12. The method according to claim 1, wherein the transport loading aids are sorted into a particular sequence by an automatic sorting device and are separately transported to an article transferring position at the automatic unloading station in this sequence, at which one or multiple articles required for the first or second picking order, are respectively transferred from the transport loading aids.

13. The method according to claim 1, wherein transport loading aids are sorted by an automatic sorting device into a first group of transport loading aids, which contains the one or multiple articles of the first picking order, and/or into a second group of transport loading aids, which contains the one or multiple articles of the second picking order, and the transport loading aids are transported separated according to groups of transport loading aids and individually to an article transferring position, at which the articles are transferred in succession from the transport loading aids.

14. The method according to claim 1, wherein the transport loading aids respectively comprise a transport bag and are moved along an overhead conveying device, wherein the articles are stored in the transport bags.

15. The method according to claim 1, wherein the first picking order and second picking order differ from each other in an order structure.

16. The method according to claim 1, wherein at least one order line and a packaging requirement are acquired in terms of data technology for each picking order, wherein the order line specifies an article according to its type of article and the number of the articles of this type of article comprised by the picking order, and wherein the packaging requirement specifies whether a shipping package or a secondary package is to be used.

17. The method according to claim 3, wherein the use of a shipping package and its type of shipping package is specified with the packaging requirement if the number of standardized types of shipping package with different dimensions is provided.

18. The method according to claim 4, wherein the use of a secondary package and its type of secondary package is specified with the packaging requirement if a number of types of secondary package with different dimensions and/or different packaging materials is provided.

19. The method according to claim 1, wherein the secondary package is made to size, individually and on the basis of the second picking order, by an automatic packaging provisioning machine.

20. An order picking warehouse for picking and packaging articles, comprising:
an order management system for electronically acquiring picking orders for orders by article recipients,
transport loading aids for providing the articles,
an automatic unloading station for automatically unloading the transport loading aids, which respectively transport one or multiple articles,
a conveying system for transporting the transport loading aids to the automatic unloading station and for transporting the transport loading aids away from the automatic unloading station,
wherein the automatic unloading station is configured for processing a first picking order and a second picking order and comprises:
a provisioning device for selectively providing a shipping package or a collective loading aid at the unloading station,
wherein the shipping package is configured for receiving one or multiple articles for the first picking order and intended for being delivered to an article recipient,
wherein the collective loading aid is configured for assembling one or multiple articles for the second picking order,
an unloading device for the order-oriented unloading of the articles for the first picking order by transferring one or multiple articles from one transport loading aid or multiple transport loading aids into the shipping package, which is provided at the unloading station, or for the order-oriented unloading of the articles for the second picking order by transferring one or multiple articles from one transport loading aid or multiple transport loading aids into the collective loading aid, which is provided at the unloading station, and
a conveying system for transporting the shipping package or the collective loading aid away from the unloading station, and the order picking warehouse further comprises:
a packaging station for reloading the one or multiple articles from the collective loading aid into a secondary package, which is intended for being delivered to an article recipient, once the second picking order has been processed at the unloading station, and which is connected to the unloading station in terms of conveyance by the conveying system for transporting the collective loading aid.

21. The order picking warehouse according to claim 20, wherein the conveying system has an overhead conveying device for transporting the transport loading aids to the automatic unloading station and for transporting the transport loading aids away from the automatic unloading station and the transport loading aids respectively comprise a transport bag for transporting one or multiple articles.

22. The order picking warehouse according to claim 21, wherein the transport bag comprises a bag body which is adjustable between a transport position and an unloading position, wherein the one or multiple articles can be supported in the bag body in the transport position and the one or multiple articles can be unloaded from the bag body in the unloading position.

23. The order picking warehouse according to claim 22, wherein the unloading station comprises an opening device, by means of which the bag body can be adjusted from the transport position to the unloading position for unloading a transport loading aid.

24. The order picking warehouse according to claim 20, wherein the provisioning device
comprises a shipping package buffer with buffer locations for providing a number of standardized types of shipping package with different dimensions and a transfer device for dispensing a shipping package selected from one of the types of shipping package on the basis of the first picking order,
wherein the conveying system is connected to the transfer device in terms of conveyance and is configured for transporting a shipping package of the selected type of shipping package from the shipping package buffer to the unloading station, and
wherein the shipping package buffer is connected to an electronic control unit by which a selecting of one of the types of shipping package on the basis of the first picking order is executed and which is configured for controlling the transfer device.

25. The order picking warehouse according to claim 20, wherein the provisioning device
comprises a collective loading aid buffer with buffer locations for providing a number of collective loading aids and a transfer device for dispensing a collective loading aid on the basis of the second picking order, and
wherein the conveying system is connected to the transfer device in terms of conveyance and is configured for transporting a collective loading aid from the collective loading aid buffer to the unloading station,
wherein the collective loading aid buffer is connected to an electronic control unit in order to control the transfer device.

26. The order picking warehouse according to claim 20, wherein the conveying system is configured for transporting the shipping packages and the collective loading aids.

27. The order picking warehouse according to claim 20, wherein a single article takeover position is provided at the unloading station, at which the article can be taken over selectively by the shipping package, in particular by the shipping package of the selected type of shipping package, for the first picking order or by the collective loading aid for the second picking order.

28. The order picking warehouse according to claim 20, wherein the packaging station comprises an automatic packaging provisioning machine, which is configured for making the secondary package to size, individually and on the basis of the second picking order.

29. The order picking warehouse according to claim 20, wherein the unloading device comprises a transferring unit, which is configured for taking over the article from the transport loading aid and transferring the article to the shipping package or to the collective loading aid, wherein
the transferring unit comprises a chute, onto which the article can be transferred, and a stop element, against which the article can be positioned, by the force of gravity, wherein the stop element defines a bottom end of the chute,
the chute has a handover unit, in particular a trap door, by which the article can be transferred downwardly.

30. The order picking warehouse according to claim 29, wherein the conveying system is configured for positioning the shipping package or the collective loading aid below the handover unit, so that the article can be transferred by being dropped from the chute into the shipping package or into the collective loading aid.

31. The order picking warehouse according to claim 29, wherein a collecting unit is arranged below the handover unit between the conveying system and the chute, which collecting unit comprises a support for receiving an article transferred by the handover unit and a scraper, wherein the support and the scraper are movable relative to each other along a horizontal axis in order to wipe the article off the support, and wherein the conveying system is configured for positioning the shipping package or the collective loading aid -below the support, so that the article can be transferred into the shipping package or into the collective loading aid by being scraped off the support.

32. The order picking warehouse according to claim 31, wherein the support is mounted so as to be rotatable about a vertical axis.

33. The order picking warehouse according to claim 29, wherein the transferring unit comprises adjustment elements that are controllable, in particular by the control unit, by which adjustment elements an inclination of the chute can be set.

34. The order picking warehouse according to claim 29, wherein the chute has an inclination of at least 15° up to a maximum of 45°.

35. The order picking warehouse according to claim 29, wherein the chute has a V-shaped cross section and/or a lateral guide for the article along a longitudinal axis of the chute.

36. The order picking warehouse according to claim 29, wherein the transferring unit comprises a vibrating device, which is arranged below the trap door and is configured for pivoting the shipping package or the collective loading aid while the article is transferred into the shipping package or into the collective loading aid.
